(19) United States
(12) Patent Application Publication
(10) Pub. No.: US 2023/0344262 A1
(43) Pub. Date: Oct. 26, 2023

(54) SYSTEM AND METHOD FOR VARIABLE DISCHARGING TECHNIQUES OF A BATTERY CELL

(71) Applicant: Apple Inc., Cupertino, CA (US)

(72) Inventors: Hyea Kim, Campbell, CA (US); OuJung Kwon, Cupertino, CA (US)

(21) Appl. No.: 17/860,806

(22) Filed: Jul. 8, 2022

Related U.S. Application Data
(60) Provisional application No. 63/334,571, filed on Apr. 25, 2022.

(51) Int. Cl. H02J 7/00; H01M 10/44; H01M 10/0525

(52) U.S. Cl. CPC H02J 7/007182; H01M 10/44; H01M 10/0525

(57) ABSTRACT

The present disclosure is directed to variable discharging protocols for one or more battery cells of a lithium-ion battery that improve the lifetime of the lithium-ion battery and/or the cell capacity of the battery. A battery management unit (BMU) controller of the lithium-ion battery may determine a number of cycles undergone by the one or more battery cells and modify a cut-off voltage (e.g., a lower cut-off voltage) based on the number of cycles. For example, the BMU controller may decrease the LCV after the number of cycles exceeds a threshold or is within a threshold range.

### CROSS-REFERENCE TO RELATED APPLICATIONS

This application claims priority to and benefit of U.S. Provisional Application No. 63/334,571, filed Apr. 25, 2022, and entitled “SYSTEM AND METHOD FOR VARIABLE DISCHARGING TECHNIQUES OF A BATTERY CELL,” which is incorporated herein by reference in its entirety for all purposes.

### BACKGROUND

The present disclosure relates generally to a battery system of an electronic device, and more specifically to managing battery cell capacity to maximize its longevity (cycle life) and energy gain.

An electronic device, such as a laptop, phone, or other portable electronic device, may include a battery system to provide power to operating components of the electronic device. The battery system may include a rechargeable battery cell, such as a lithium-ion battery cell, that powers the operating components of the electronic device at least when the electronic device is not connected (e.g., via an adapter or converter) to a separate power source, such as an electrical grid via a wall outlet, an external battery, a generator, and so on. The separate power source may be used at certain intervals to power the operating components of the electronic device and to replenish a charge of the battery cell for current or future use.

As the lithium-ion battery is repeatedly discharged (e.g., via use of the electronic device powered by the lithium-ion battery) and charged, the usable cell capacity (e.g., usable capacity) of the lithium-ion battery cells may decrease due to the occurrence of degradation phenomena, such as increase in cell resistance, structural stress from volume expansion of the cells, lithium-plating on the cells, thermal decomposition of electrolyte in the cells, and the like. In certain techniques, the electronic device may be programmed to power down or deactivate when the cell voltage of a lithium-ion battery is equal to a predetermined lower cut-off voltage (LCV) that may be selected to maximize or increase the cell capacity provided by the lithium-ion battery and minimize or decrease onset of the degradation phenomena. A lithium-ion battery used to power certain electronic devices has an LCV and upper cut-off voltage (UCV) which defines the charge and discharge voltage window. The voltage window range decides the amount of initially usable cell capacity. As such, the lithium-ion battery may provide power to the electronic device until the cell voltage reaches the LCV (e.g., via discharging), after which the battery is charged to an upper UCV. This process may be repeated through use of the device until the usable cell capacity of the lithium-ion battery (e.g., cell life of the one or more battery cells of the lithium-ion battery) drops below a threshold percentage of the lithium-ion battery's initial capacity. As referred to herein, the lifetime of a battery cell refers to a number of cycles undergone by the battery. As referred to herein, a cycle generally includes a charge and/or a discharge of the battery. Accordingly, a number of cycles undergone by the battery may include a number of times a battery was charged, a number of times a battery was discharged, or both. At least in certain battery compositions used to power electronic devices, the onset of degradation phenomena may outweigh potential benefits to the cell capacity that arise from lowering the LCV. For example, decreasing the LCV below 3.0 V in lithium-ion batteries may reduce the lifetime of the lithium-ion battery. Accordingly, it may be advantageous to develop techniques to improve the lifetime of existing lithium-ion batteries.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, the present disclosure relates to a system. The system includes a lithium-ion battery having an anode having a silicon anode material. The system also includes a battery management subsystem electrically coupled to the lithium-ion battery, wherein the battery management subsystem includes one or more processors that determine a number of cycles undergone by the lithium-ion battery based on a voltage of the lithium-ion battery being below a cut-off voltage. The one or more processers also modify the cut-off voltage to a modified cut-off voltage for the lithium-ion battery based on the number of cycles undergone by the lithium-ion battery.

In another embodiment, the present disclosure relates to a method. The method includes determining, via one or more processors of an electronic device, a voltage of a lithium-ion battery of the electronic device, wherein the lithium-ion battery has a silicon anode material. The method also includes determining, via the one or more processors, that the voltage is less than a cut-off voltage. Further, the method includes determining, via the one or more processors, a number of cycles undergone by the lithium-ion battery based on the voltage being less than the cut-off voltage. Further still, the method includes decreasing, via the one or more processors, the cut-off voltage based on the number of times the lithium-ion battery has been discharged being greater than a threshold.

In yet another embodiment, the present disclosure relates to a battery management system electrically coupled to a lithium-ion battery. The lithium-ion battery includes a silicon anode material. The battery management system includes one or more processors that determine a number of cycles undergone by the lithium-ion battery in response to determining that a voltage of the lithium-ion battery is below a cut-off voltage. The one or more processors also modify the cut-off voltage for the lithium-ion battery based on the number of cycles to increase cell capacity of the lithium-ion battery by greater than 3% as compared to not modifying the cut-off voltage.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic diagram of an electronic device, according to an embodiment of the present disclosure;

FIG. 2 is a block diagram of a battery system of the electronic device of FIG. 1, according to an embodiment of the present disclosure;

FIG. 3 is a schematic diagram of a battery cell of the battery system of FIG. 2, according to embodiments of the present disclosure;

FIG. 4 is a flow diagram of a method for modifying a cut-off voltage of a lithium-ion battery having the battery cell of FIG. 3, according to embodiments of the present disclosure;

FIG. 5 is a graph depicting managing cell capacity of a lithium-ion battery having a graphite anode;

FIG. 6 is a graph depicting managing cell capacity of a lithium-ion battery having the battery cell of FIG. 3, according to embodiments of the present disclosure;

FIG. 7 is a graph depicting capacity retention versus cycle number for cycles with varying low cut-off voltage (LCV) values for lithium-ion battery having the battery cell of FIG. 3, according to embodiments of the present disclosure;

FIG. 8 is a graph depicting cell capacity versus cycle number for discharge cycles with varying low cut-off voltage (LCV) values for lithium-ion battery having the battery cell of FIG. 3, according to embodiments of the present disclosure;

FIG. 9A is a graph depicting capacity retention (%) versus cycle number for an alternating discharge protocol and a static discharge protocol at 25° C. for lithium-ion battery having the battery cell of FIG. 3, according to embodiments of the present disclosure;

FIG. 9B is a graph depicting energy retention (%) versus cycle number for an alternating discharge protocol and a static discharge protocol at 25° C. for lithium-ion battery having the battery cell of FIG. 3, according to embodiments of the present disclosure;

FIG. 9C is a graph depicting capacity retention (%) versus cycle number for a gradually decreasing discharge protocol and a static discharge protocol at 25° C. for lithium-ion battery having the battery cell of FIG. 3, according to embodiments of the present disclosure;

FIG. 9D is a graph depicting energy retention (%) versus cycle number for a gradually decreasing discharge protocol and a static discharge protocol at 25° C. for lithium-ion battery having the battery cell of FIG. 3, according to embodiments of the present disclosure;

FIG. 10A is a graph depicting capacity retention (%) versus cycle number for an alternating discharge protocol and a static discharge protocol at 45° C. for lithium-ion battery having the battery cell of FIG. 3, according to embodiments of the present disclosure;

FIG. 10B is a graph depicting energy retention (%) versus cycle number for an alternating discharge protocol and a static discharge protocol at 45° C. for lithium-ion battery having the battery cell of FIG. 3, according to embodiments of the present disclosure;

FIG. 10C is a graph depicting capacity retention (%) versus cycle number for a gradually decreasing discharge protocol and a static discharge protocol at 45° C. for lithium-ion battery having the battery cell of FIG. 3, according to embodiments of the present disclosure;

FIG. 10D is a graph depicting energy retention (%) versus cycle number for a gradually decreasing discharge protocol and a static discharge protocol at 45° C. for lithium-ion battery having the battery cell of FIG. 3, according to embodiments of the present disclosure;

FIG. 11A is a graph depicting capacity retention (%) versus throughput capacity (Ah) for an alternating discharge protocol, a gradually decreasing discharge protocol, and a static discharge protocol at 25° C. for lithium-ion battery having the battery cell of FIG. 3, according to embodiments of the present disclosure;

FIG. 11B is a graph depicting energy retention (%) versus throughput energy watt hour (Wh) for an alternating discharge protocol, a gradually decreasing discharge protocol, and a static discharge protocol at 25° C. for lithium-ion battery having the battery cell of FIG. 3, according to embodiments of the present disclosure;

FIG. 11C is a graph depicting capacity retention (%) versus throughput capacity (Ah) for an alternating discharge protocol, a gradually decreasing discharge protocol, and a static discharge protocol at 45° C. for lithium-ion battery having the battery cell of FIG. 3, according to embodiments of the present disclosure; and

FIG. 11D is a graph depicting energy retention (%) versus throughput energy (Wh) for an alternating discharge protocol, a gradually decreasing discharge protocol, and a static discharge protocol at 45° C. for lithium-ion battery having the battery cell of FIG. 3, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

This disclosure is directed to techniques for improving lifetime of batteries and/or battery cells, such as lithium-ion battery cells, that are used to power electronic devices while reducing a likelihood of damaging the battery cells. As generally described above, one or more lithium-ion battery cells of a lithium-ion battery may provide power to an electronic device until a cell voltage of the lithium-ion battery reaches a lower cut off voltage (LCV) (e.g., cut-off voltage). The LCV is a predetermined cell voltage limit or threshold that is generally selected to provide a maximum or increased usable cell capacity of the lithium-ion battery, while minimizing or decreasing an onset of the degradation phenomena. As the lithium-ion battery is repeatedly discharged and charged, the usable cell capacity of the lithium-ion battery may decrease due to the occurrence of degradation phenomena that may reduce the cell capacity of the lithium-ion battery. As the cell capacity of the lithium-ion battery decreases, the lifetime of the lithium-ion battery decreases, which may result in shorter discharge times (e.g., due to the battery holding less charge than the battery may have initially) and, ultimately, a need to replace the lithium-ion battery.

Embodiments herein provide various apparatuses and techniques to increase the lifetime of a battery while decreasing or minimizing damage to anodes of the battery resulting from certain degradation phenomena. In addition, the embodiments provide various apparatuses and techniques to maximize the energy or capacity throughput without reducing the cycle life. To do so, embodiments disclosed herein include a battery management unit (BMU) controller of a lithium-ion battery system that utilizes a variable discharging protocol (e.g., variable discharging technique, variable charging protocol, and so on, including an alternating and/or gradually decreasing discharging protocol) to improve a lifetime and/or energy gain between charge cycles of the battery. More specifically, the variable discharging or charging protocol includes modifying (e.g., increasing or decreasing) a cut off voltage (e.g., the LCV, an upper cutoff voltage (UCV), or both) associated with the lithium-ion battery based on a number of cycles (e.g., complete or partial) undergone by the lithium-ion battery or one or more battery cells of the lithium-ion battery. For example, it is presently recognized that decreasing the LCV after a particular number of cycles may provide additional cell capacity to the lithium-ion battery while also providing an energy gain between cycles throughout the lifetime of the lithium-ion battery. As such, the BMU may enable a battery cell to provide power to an electronic device for a greater number of charge cycles. For example, the BMU may periodically (e.g., after a predetermined number of charge cycles) decrease the LCV to a voltage such that the cell capacity of the lithium-ion battery may increase as compared to the LCV not being so modified (i.e., not modifying the cut-off voltage). Further, it is presently recognized that it may be advantageous to utilize the disclosed techniques for certain battery compositions, such as lithium-ion batteries having silicon-containing electrodes.

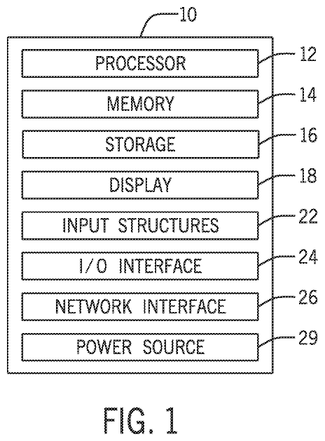

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a satellite network, a non-terrestrial network, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

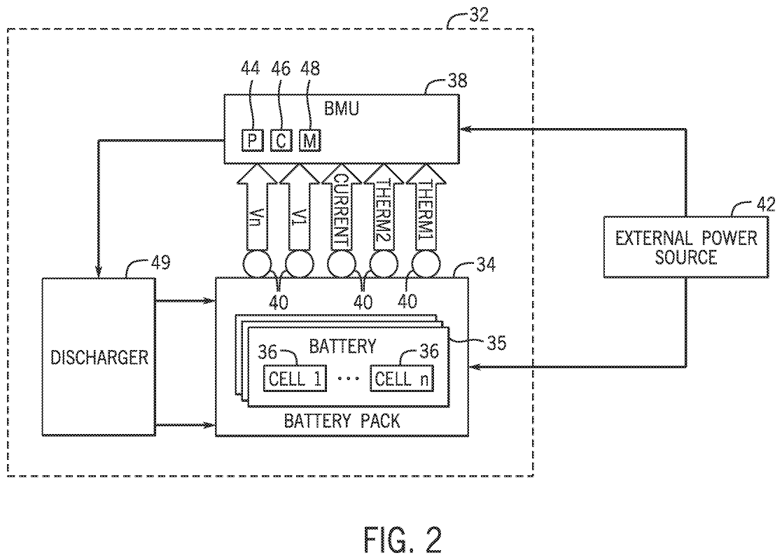

FIG. 2 is a block diagram of an embodiment of a battery system 32 of the electronic device 10 of FIG. 1. In particular, the battery system 32 may be at least part of the power source 29 of the electronic device 10 as described in FIG. 1. In the illustrated embodiment, the battery system 32 includes a battery pack 34 having one or more batteries 35, each battery 35 having one or more battery cells 36, and a battery management unit (BMU) controller 38 electrically coupled to the one or more battery cells 36 that controls operation of the battery system 32. The battery system 32 may also include one or more sensors 40 that generally obtain, measure, or detect properties, such as a voltage, a current, a temperature, and other properties of the battery cells 36 that may be used to, for example, determine a state of charge (SOC) of a battery 35. For example, the sensors 40 may include a temperature sensor, such as a thermocouple, that detects a temperature of the battery cell 36 (e.g., or the battery 35) and/or otherwise enables the BMU controller 38 to determine the temperature of the battery cell 36. For example, if the sensor 40 is a thermocouple, the sensor 40 may produce a temperature-dependent voltage across two dissimilar electrical conductors, and the BMU controller 38 may determine the temperature-dependent voltage and determine the temperature of the battery cell 36 therefrom. However, other types of sensors 40 are also contemplated, such as a thermistor (e.g., having a temperature-dependent resistance that enables determining the temperature of the battery cell 36) or an infrared sensor. Additionally, the sensors 40 may include voltage meters, ammeters, and other devices that may measure an electrical property that may be used to determine or calculate the SOC. It should be noted that, in some embodiments, the battery system 32 may include multiple instances of the battery cell 36 and multiple instances of the sensors 40 corresponding to the multiple instances of the battery cell 36. Further, it should be noted that references to the battery 35 herein may apply to the battery cells 36 and/or the battery pack 34, and references to the battery cells 36 herein may apply to the battery 35 and/or battery pack 34.

The batteries 35 (e.g., or the battery cells 36 of a battery 35) of the battery pack 34 may be charged by an external power source 42 (e.g., which may also be part of the power source 29 of the electronic device 10 shown in FIG. 1), such as an electrical grid via a wall outlet, an external battery, a generator, and so on. The battery system 32 may be coupled to the power source 42 via an adapter, converter, or connector (e.g., wired or wireless) associated with the electronic device 10 of FIG. 1. The power source 42 may power the BMU controller 38 when the power source 42 is connected to the battery system 32, although the BMU controller 38 may be powered by the battery 35 (or other suitable power source) when the power source 42 is not connected to the battery system 32. In some embodiments, the sensors 40 may be self-powered, meaning that the sensors 40 may operate without an external power source.

The BMU controller 38 may include processing circuitry 44, communication circuitry 46, and memory circuitry 48. The processing circuitry 44 (which may be part of the processor 12 of the electronic device 10 shown in FIG. 1) may execute instructions stored on the memory circuitry 48 (which may be part of the memory 14 of the electronic device 10 shown in FIG. 1) to perform various functions associated with the battery system 32. In some embodiments, the memory circuitry 48 may store reference data indicating variable discharging protocols that may be used by the BMU controller 38 to determine the LCV for the battery 35. Additional details regarding such variable discharging protocols are discussed with respect to Table 1 and FIG. 4 below. In particular, the BMU controller 38 may selectively activate the discharger 49 to discharge the battery 35 during certain operating conditions. In general, the discharger 49 may draw current from the battery 35 to discharge the battery 35. At least in some instances, it may be advantageous to discharge the battery 35 to a predetermined battery voltage before charging the battery 35. As such, in one embodiment, the BMU controller 38 may activate the discharger 49 in response to determining, via the processing circuitry 44, that the cell voltage of the battery 35 is above a threshold.

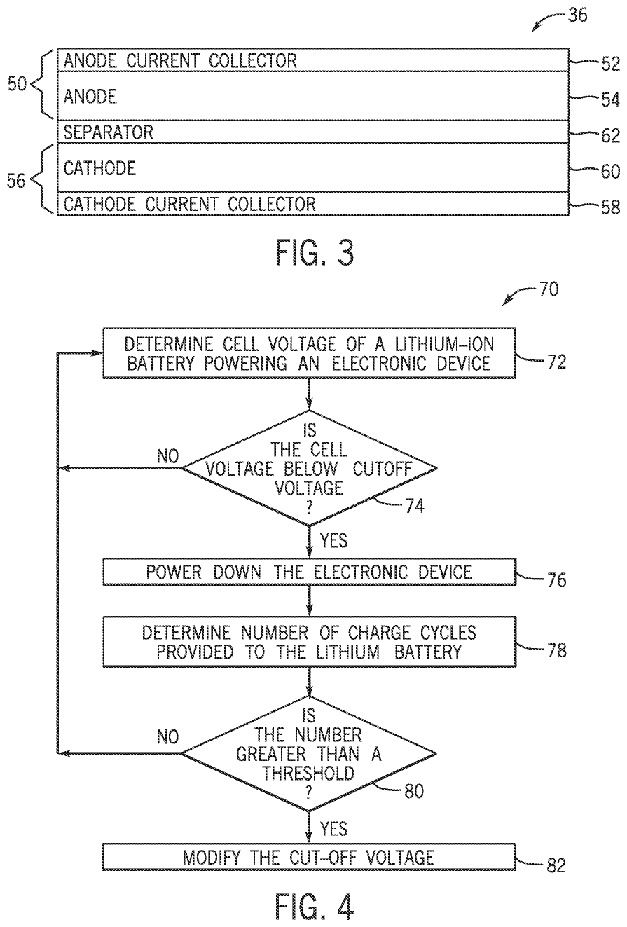

As described herein, the battery 35 of the battery pack 34 may include a lithium-ion battery cell. To illustrate this, FIG. 3 is a schematic diagram of an embodiment of the battery cell 36, according to aspects of the present disclosure. As illustrated, the battery cell 36 has an anode 50 with an anode current collector 52 and an anode active material 54 disposed on the anode current collector 52. As illustrated, the lithium-ion battery cell 36 also has a cathode 56 with a cathode current collector 58 and a cathode active material 60 disposed over the cathode current collector 58. In some embodiments, the cathode 56 and the anode may be separated by a separator 62 and/or an electrolyte.

The cathode current collector 58 may include an aluminum sheet or foil. Cathode active materials 60 may include one or more lithium transition metal oxides and/or lithium metal phosphate that may be bonded together using binders and, optionally, conductive fillers, such as carbon black. Lithium transition metal oxides may include a lithium cobalt oxides (LCO), a lithium nickel oxides (LNO), or other suitable transition metal oxides. More specifically, such lithium transition metal oxides may include, but are not limited to, LiCoO₂, LiNiO₂, LiNi_{0.8}Co_{0.15}Al_{0.05}O₂, LiMnO₂, Li(Ni_{0.5}Mn_{0.5})O₂, LiNiₓO_{y}Mn_{z}O₂, Spinel LiMn₂O₄, and other polyanion compounds, and other olivine structures including LiFePO₄, LiMnPO₄, LiCoPO₄, LiMnₓFe₁₋ₓPO₄, LiNi_{0.5}Co_{0.5}PO₄, and LiMn_{0.33}Fe_{0.33}Co_{0.33}PO₄. At least in some instances, the cathode active material 60 may include an electroconductive material, a binder, etc.

The anode active material 54 (e.g., anode material) may include a silicon-based material (e.g., silicon anode material(s) or silicon material), whether a micron-sized particle, nanoparticle, or larger size particle of silicon. For example, the silicon-based material includes, but not limited to silicon and/or silicon oxide based materials, silicon carbon composite materials, and/or silicon alloys, such as alloys including tungsten aluminum, nickel, copper, magnesium, tin, germanium, and/or zinc. In an embodiment where the anode active material 54 are particles (e.g., micron-sized particles, nanoparticles, or larger particles), the particles may have a distribution of shapes. For example, the anode active material 54 may include micron-sized particles that are 10%, 20%, 30%, 40%, 50%, 60%, 70%, 80% 90%, or 95% spherical. As another non-limiting example, the anode active material 54 may include nano-sized particles that are 10%, 20%, 30%, 40%, 50%, 60%, 70%, 80% 90%, or 95% spherical. At least in some instances, the combination of particle shapes (e.g., spherical, rod-like, nanowire) and different size distributions may tailor the properties of the resulting anode active material 54 discussed herein. For example, the silicon-based materials may include morphologies, such as nanoparticles, nanocrystals, nanowires, secondary particle which contains smaller sub-particles that can be physically agglomerated, or interconnected to each other, and the like. Additionally, the silicon- based materials may include crystalline silicon and/or amorphous silicon. The anode current collector 52 may include a copper or nickel sheet or foil, as a non-limiting example.

Any suitable electrolyte, such as a liquid electrolyte, a gel electrolyte, a solid electrolyte, or a polymer electrolyte, known to those skilled in the art may be used. In some embodiments, the liquid electrolyte may be provided as a solution in which a lithium salt is dissolved in an organic solvent. A gel electrolyte may be provided as a gel in which the above mentioned liquid electrolyte is impregnated into a matrix polymer composed of an ion conductive polymer. When the electrolyte layers are formed by a liquid electrolyte or gel electrolyte, a separator 62 may be used in the electrolyte layer. Examples of the separators include porous films of polyolefin, such as polyethylene and polypropylene.

As described herein, it may be advantageous to modify the LCV for the battery 35 based on a number of cycles undergone by the battery 35 (e.g., the number of charge and discharge cycles undergone by the battery 35). To illustrate this, FIG. 4 is a flowchart of a method 70 for the BMU 38 to improve the cell capacity and lifetime of a lithium ion battery 35 by modifying the LCV (e.g., cut-off voltage) of the battery 35, according to embodiments of the present disclosure. Any suitable device (e.g., a controller) that may control components of the battery system 32, such as the BMU 38, the electronic device 10, the processor 12, and/or the processing circuitry 44, may perform the method 70. In some embodiments, the method 70 may be implemented by executing instructions stored in a tangible, non-transitory, computer-readable medium, such as the memory 48, the memory 14, and/or storage 16, using the processing circuitry 44 and/or the processor 12. For example, the method 70 may be performed at least in part by one or more software components, such as an operating system of the electronic device 10, one or more software applications of the electronic device 10, firmware of the electronic device 10, and the like. While the method 70 is described using steps in a specific sequence, it should be understood that the present disclosure contemplates that the described steps may be performed in different sequences than the sequence illustrated, and certain described steps may be skipped or not performed altogether.

In process block 72, the processing circuitry 44 determines a cell voltage of a lithium-ion battery 35 used to power the electronic device 10. In particular, the processing circuitry 44 may receive measurements (e.g., voltage measurement, temperature measurement, current measurement, and so on) acquired by the sensors 40 (e.g., voltage sensor, temperature sensor, current sensor, and so on) and determine the cell voltage of the lithium-ion battery based on the measurements. For example, if the sensors 40 include a voltage sensor, the processing circuitry 44 may receive a voltage measurement via the voltage sensor 40. In turn, the processing circuitry may determine a state of charge or cell voltage based on the voltage measurement, temperature measurement, or other parameter that may be used to determine the state of charge as understood by one of ordinary skill in the art.

In decision block 74, the processing circuitry 44 compares the cell voltage to the cut-off voltage (e.g., LCV). As discussed herein, the LCV refers to the cell voltage of the battery 35 at which the processing circuitry 44 may prevent the battery 35 from providing power to the electronic device 10. For example, the LCV may be a threshold (e.g., a minimum threshold) of the battery 35 for providing power to the electronic device 10. In some embodiments, the processing circuitry 44 may retrieve or receive reference data from the memory circuitry 48, or other suitable memory, that stores reference LCVs for a given number of cycles or indicates a current LCV set by the electronic device 10 and/or BMU 38. As such, the processing circuitry 44 may determine the number of cycles undergone by the lithium-ion battery 35 (e.g., as described below with respect to block 78) or a value indicating the LCV by retrieving or receiving data indicating the LCV that is stored in the memory circuitry 48. Further, the processing circuitry 44 may compare the cell voltage determined at block 72 to the determined cut-off voltage. Accordingly, if the processing circuitry 44 determines that the cell voltage of the lithium-ion battery 35 is below or equal to the cut-off voltage, then the processing circuitry 44 may proceed to block 76. However, if the processing circuitry 44 determines that the cell voltage of the lithium-ion battery is above the cut-off voltage, then the processing circuitry 44 may return to block 72.

As described above, if the processing circuitry 44 determines that the cell voltage of the lithium-ion battery 35 is below or equal to the cut-off voltage, then the processor circuitry 44 may proceed to block 76. In process block 76, the processing circuitry 44 powers down, turns off, or deactivates the electronic device 10. In particular, the processing circuitry 44 outputs a control signal that triggers deactivation of the electronic device 10.

In some embodiments, the processing circuitry 44 may activate the discharger 49 (e.g., as described above with respect to FIG. 2) during or after shutdown of the electronic device 10 to reduce the cell voltage of the battery 35 to a particular cell voltage that may improve charge memory (e.g., ability to return the previous cell capacity) of the battery 35. For example, the processing circuitry 44 may indicate (e.g., display an indication on the display 18 of the electronic device 10) that the battery 35 of the electronic device 10 should not be discharged, or the electronic device 10 should not be otherwise coupled to an external power source. That is, if the processing circuitry 44 receives an indication that the battery 35 is being discharged (e.g., indicating that the electronic device 10 is coupled to the external power source), the processing circuitry 44 may determine whether the cell voltage of the battery 35 is above a threshold (e.g., within a threshold range between the LCV and the UCV). If the processing circuitry 44 determines that the battery 35 is being discharged and the cell voltage is above the threshold, the processing circuitry 44 may cause the display 18 of the electronic device 10 to display the notification that the battery 35 of the electronic device 10 should not be charged, or the electronic device 10 should not be otherwise coupled to an external power source. At least in some instances, if the processing circuitry 44 determines that the battery 35 is coupled to an external power source and the cell voltage is above the threshold, the processing circuitry 44 may block or prevent the electronic device 10 from being discharged.

In additional or alternative embodiments, the processing circuitry 44 may determine whether to discharge the battery 35 based on a current time at which the electronic device 10 is coupled to the external power source. For example, the processing circuitry 44 may determine the current time and/or whether there is sufficient time to discharge the battery 35 (e.g., based on an average time or duration the electronic device 10 is coupled to the external power source and not being in active use) before the processing circuitry proceeds to discharge the battery via the discharger 49. Active use may include use of the electronic device 10 via the input/output (I/O) interface 24, the display 18 being active, a user actively using the electronic device 10, and so on. As such, if the current time is during a period of time corresponding to low usage (e.g., the device 10 being inactive for longer than a threshold time) and/or there is sufficient time to charge the battery 35 (e.g., the average time that the electronic device 10 is not being in active use and coupled to the external power source and/or the electronic device 10 is in an inactive state, such as a sleep mode or a unpowered mode), the processing circuitry 44 may activate the discharger 49. At least in some instances, the processing circuitry 44 may cause the display 18 of the electronic device 10 to display the notification that the battery 35 of the electronic device 10 should not be uncoupled from the external power source and/or a time period corresponding to when the battery 35 will be sufficiently charged. In this way, the disclosed techniques may improve the lifetime of the battery 35 while not interrupting active use of the electronic device 10.

In additional or alternative embodiments, the processing circuitry 44 may cause the display 18 of the electronic device 10 to display a notification corresponding to a cell voltage of the battery 35 being within a threshold voltage window, as compared to notification a number that directly indicates a remaining usable cell capacity (e.g., 50%, 60%, 70%, 80%) corresponding to the cell voltage. It is presently recognized that displaying a notification corresponding to the cell voltage of the battery 35 being with a threshold voltage window may improve charge memory (e.g., ability to return the previous cell capacity) of the battery 35. For example, the threshold voltage window may include cell voltages between the LCV and the UCV of the battery 35. As such, if the processing circuitry 44 determines that the cell voltage is between the LCV and the UCV of the battery 35, the processing circuitry 44 may indicate (e.g., display an indication on the display 18 of the electronic device 10) that the battery 35 of the electronic device 10 should not be discharged, or the electronic device 10 should not be otherwise coupled to an external power source. In such an embodiment, the notification may indicate that the cell capacity is approximately 100%, above 90%, above 80%, or other suitable values indicating the remaining usable cell capacity, although the remaining usable capacity may be lower. At least in some instances, the processing circuitry 44 may determine the threshold voltage window based on usage trends of the electronic device 10. For example, the processing circuitry 44 may determine the cell voltage of the battery 35 after the electronic device 10 is coupled to an external power source. As such, the processing circuitry 44 may adjust or set the threshold voltage window such that it includes the cell voltage of the battery 35 when it was initially coupled to the external power source. In this way, the disclosed techniques may improve the lifetime of the battery 35 by preventing the electronic device 10 from being charged before the cell voltage of the battery 35 decreases to the LCV.

In decision block 78, the processing circuitry 44 determines the number of cycles undergone by the lithium-ion battery 35. In particular, the processing circuitry 44 may perform block 78 while the electronic device 10 shuts down or upon powering on the electronic device 10 after the lithium-ion battery 35 has been charged to a voltage above the cut-off voltage. At least in some instances, the processing circuitry 44 may perform block 78 before or after any of the blocks of the method 70. For example, the processor 12 may perform block 78 before powering down the electronic device 10, in block 76. Additionally or alternatively, the processing circuitry 44 may perform block 78 before performing block 74. For example, the processing circuitry 44 may determine the number of cycles undergone by the lithium-ion battery 35, and determine a cut-off voltage associated with the number of cycles.

In process block 80, the processing circuitry 44 determines whether the number of cycles is greater than or equal to a threshold, less than or equal to a threshold, or within a threshold range. As discussed herein, the number of cycles refers to a number of times when the battery 35 was charged to a relatively higher voltage state (e.g., 90%, 80%, 70%, and the like) from a relatively lower voltage state (e.g., as compared to the battery 35 being at or near an increased or maximum voltage of the battery 35) and/or discharged due to use. That is, the number of cycles may refer to a number of times the lithium-ion battery 35 was charged, discharged, or both charge and discharged. At least in some instances, the number of cycles may be indicated by a numerical value, such as a running-sum indicating a current count of the number of cycles. For example, a value of ‘1’ may indicate that the BMU 38 provided a single cycle to the lithium-ion battery 35, and the value may be changed to ‘2’ after the BMU 38 provides an additional cycle to the lithium-ion battery 35. In such embodiments, the BMU 38 may store a fraction indicating periods where the lithium-ion battery 35 was partially discharged or partially discharged. For example, if the battery 35 was discharged from 100% of the cell capacity to 50% of the cell capacity, the memory circuitry 48 may store a ‘0.5’ or add ‘0.5’ to a count representing the number of cycles. In some embodiments, the processing circuitry 44 may utilize reference data to determine whether the number of cycles is greater than a threshold or within a threshold range. For example, the memory circuitry 48 may store data (e.g., a table or otherwise) indicating ranges of cycles, where each range corresponds to a different LCV, such as generally described with respect to the variable discharging protocols of Table 1. As such, the processing circuitry 44 may access the table and determine the corresponding LCV for a given charge cycle.

In block 82, the processing circuitry 44 modifies (e.g., increases or decreases) the cut-off voltage. In some embodiments, the processing circuitry 44 may access reference data stored in the memory circuitry 48 to determine an adjustment of the cut-off voltage. For example, during manufacturing of the electronic device 10, multiple cut-off voltages may be stored in the memory circuitry 48, each corresponding to a different number of cycles, such as in the form of the information stored in Table 1. As such, the processing circuitry 44 may compare the number of cycles (e.g., determined at block 78) to the reference data to determine a new, corresponding cut-off voltage. At least in some instances, the processing circuitry 44 may modify the cut-off voltage based on detected properties of one or more of the battery cells 36. For example, the processing circuitry 44 may modify the cut-off voltage to increase the energy gain or storage capacity of the battery 35 by greater than or equal to 3%, 5%, 7%, 9%, 11%, 13%, 15%, or 20% as compared to not modifying the cut-off voltage. As such, if the processing circuitry 44 determines that a particular cut-off voltage would increase the storage capacity by 3% (e.g., after a threshold number of cycles indicated in the reference data), the processing circuitry 44 may set the cut-off voltage to the particular cut-off voltage. In some embodiments, the processing circuitry 44 may write a value indicating the LCV to the memory circuitry 48 that the processing circuitry 44 may refer to in a subsequent occurrence of block 74.

In this manner, the method 70 enables the electronic device 10 to utilize the lithium-ion battery 35 through more cycles and for longer periods of use in between cycles, thereby reducing the frequency of replacing the lithium-ion battery 35 or the electronic device 10 shutting down during undesirable periods (e.g., while a user is using the electronic device 10).

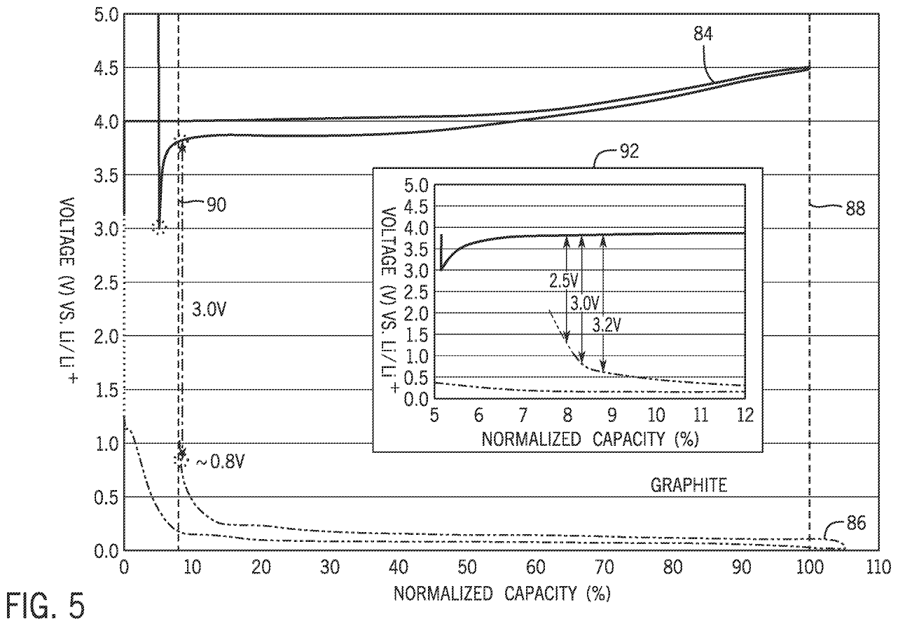

FIG. 5 is a graph with a horizontal or x-axis representing normalized capacity (%) and a vertical or y-axis representing voltage (V) vs. Li/Li⁺ of a lithium-ion battery 35. The graph of FIG. 5 includes a curve 84 for a cathode of the battery 35 and a curve 86 for a graphite anode of the battery 35. As referred to herein, the “normalized capacity” refers to the normalization of the capacity of the cathode and anode relative to the capacity of the cathode. In the depicted example, the cathode has a relatively lower capacity that than the anode. As such, the curve 84 for the cathode does not exceed 100% of the normalized capacity, while the curve 86 exceeds 100% of the normalized capacity. Referring to the graph of FIG. 5, in general, the BMU 38 may determine a cell voltage of the battery 35 based on a difference in voltage measured at the cathode and the anode, represented by a distance between the voltage of the curve 84 and the curve 86 at particular normalized capacity. For example, at 100% capacity (e.g., along dashed line 88), the cell voltage of the battery 35 is approximately 4.45V. At approximately 8% (e.g., along dashed line 90), the cell voltage of the battery 35 is approximately 3.0 V. Accordingly, the cell voltage of the battery 35 decreasing from approximately 4.45 V to 3.0 V corresponds to the usable capacity of the battery 35 decreasing from 100% to approximately 8% (i.e. 92% capacity is available between 4.45V to 3.0V). As depicted in the inset graph 92, decreasing the LCV to below 3.0 V may provide approximately an additional 1% or 2% more cell capacity as compared to not modifying or changing the LCV.

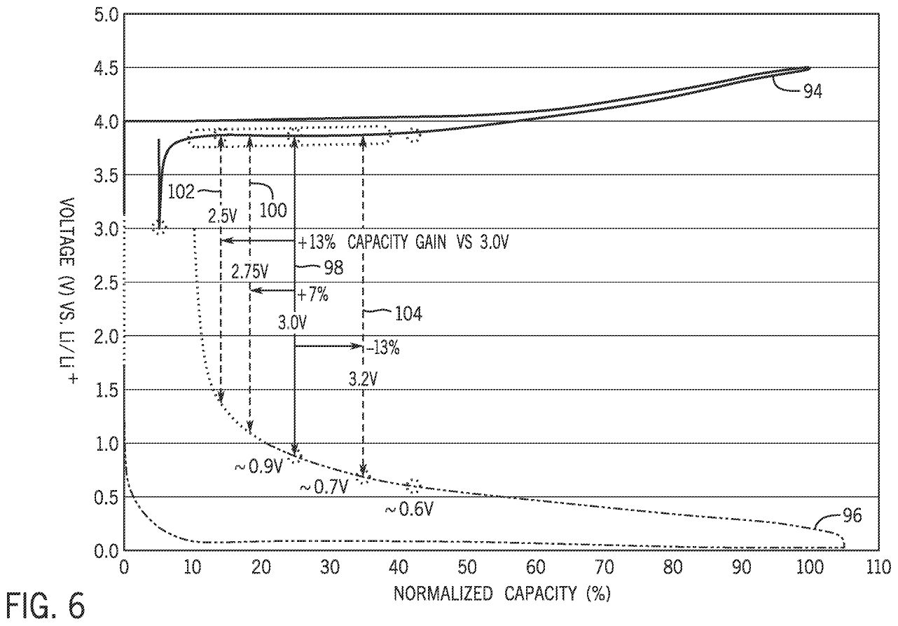

As described herein, it is presently recognized that certain lithium-ion battery compositions (e.g., having a silicon anode, such as having the silicon anode active material 54 of the battery cell 36 of FIG. 3 for a lithium-ion battery 35) may provide a larger cell capacity gain for lower cell voltages relative to a 3.0 V LCV. To illustrate this, FIG. 6 shows a graph with a horizontal or x-axis representing normalized capacity (%) and a vertical or y-axis representing voltage (V) vs Li/Li⁺ of a lithium-ion battery cell. The graph of FIG. 6 includes a curve 94 for a lithium cobalt oxide (LCO) cathode and a curve 96 for a silicon-containing anode material 54. In a generally similar manner as described with respect to FIG. 5, a cell voltage of the battery 35 may be determined based on a difference between the voltage of the curve 94 and the curve 96 at particular normalized capacity. For the lithium-ion battery 35 represented in FIG. 6, the cell voltage of the battery 35 decreasing from approximately 4.45 V to 3.0 V corresponds to the cell capacity discharging from 100% to approximately 25% (75% capacity is available between 4.45V to 3.0V) (e.g., along line 98). The cell voltage of the battery 35 decreasing from approximately 4.45V to 2.75 V corresponds to the cell capacity discharging from 100% to approximately 18% (82% usable capacity between 4.45V-2.75V) (e.g., along dashed line 100). Accordingly, discharging to the battery 35 from 4.45V to 2.75V may produce a capacity gain of approximately 7% as compared to initially set LCV of 3.0V. Further, the cell voltage of the battery 35 decreasing from approximately 4.45V to 2.5 V corresponds to the cell capacity discharging from 100% to approximately 12% (88% usable capacity between 4.45V and 2.5V) (e.g., along dashed line 102). Accordingly, discharging to the battery 35 from 4.45V to 2.5 V may produce a capacity gain of approximately 13% as compared to initially set LCV of 3.0V. Further, the cell voltage of the battery 35 decreasing from approximately 4.45 V to 3.2 V corresponds to the cell capacity discharging from 100% to approximately 38% (e.g., 52% usable capacity) (e.g., along dashed line 104). Accordingly, discharging to the battery 35 from 4.45V to 3.2 V may produce a capacity loss of approximately 13%. In this way, the battery 35 represented in FIG. 6 may produce large capacity gains (e.g., greater than 3%, 5%, 7%, 9%, 11%, 13%, 15%, or 20%) when the LCV is decreased below 3.0 V as compared to the lithium-ion battery 35 (e.g., having the graphite anode) represented in FIG. 5.

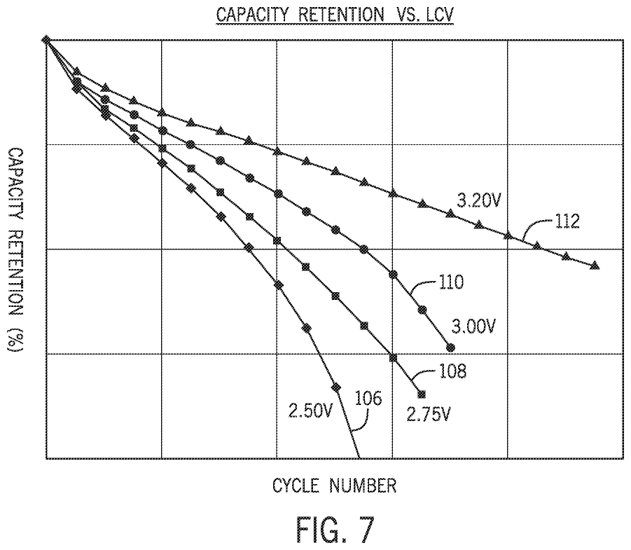

As described herein, decreasing the LCV may decrease the capacity retention of a battery 35. To illustrate this, FIG. 7 shows a graph with a horizontal or x-axis representing cycle number and a vertical or y-axis representing capacity retention (%). In the graph, the y-axis has a range from 60% to 100% and the x-axis has a range from 0 to 1000 cycles. Referring to the graph of FIG. 7, the graph includes curves 106, 108, 110, and 112 corresponding to LCV values of 2.5 V, 2.75 V, 3.00V, and 3.2 V, respectively. As generally shown in the graph, the capacity retention % may decrease more rapidly per a number of cycles as the LCV value decreases.

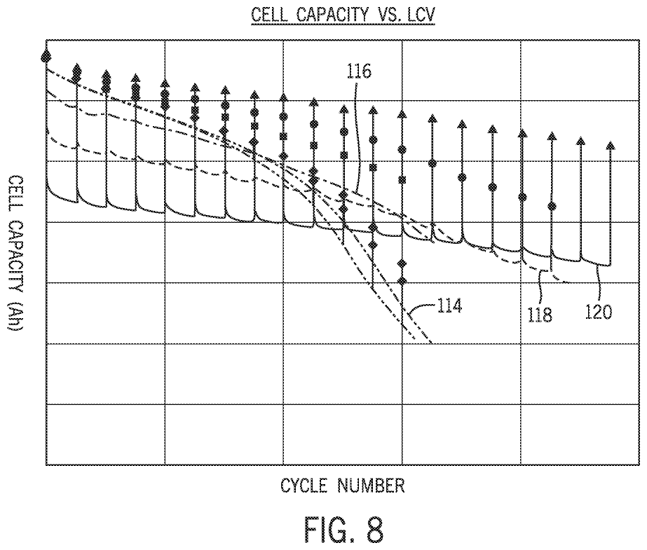

As described herein, a lower LCV may provide a higher cell capacity for a battery cell. To illustrate this, FIG. 8 shows a graph with a horizontal or x-axis representing cycle number and a vertical or y-axis representing capacity retention in ampere hours (Ah). The graph includes curves 114, 116, 118, and 120 corresponding to LCV values of 2.5 V, 2.75 V, 3.00V, and 3.2 V, respectively. As generally shown in the graph, cell capacity for lower LCV values is generally higher for lower cycle numbers. For example, discharging a battery cell to an LCV value of 2.5 V generally provides a higher cell capacity for a first number of cycles.

It is presently recognized that it may be advantageous to utilize the higher cell capacity associated with lower LCV values within certain cycles to increase the lifetime of a battery 35 and increase the duration of the battery 35 while it is discharging. To do so, the LCV may be modified accordingly based on the number of cycles performed on the battery 35. At least in some instances, the BMU 38 may periodically decrease the LCV based on the number of cycles. That is, after a first number of cycles, the BMU 38 may modify (e.g., increase or decrease) the LCV from a first value to a second value. After a second number of cycles, following the first number of cycles, the BMU 38 may modify (e.g., increase or decrease) the LCV value from a second value to a third value. In this way, the BMU 38 may reduce stress on the battery 35 due to discharging to different or variable (e.g., lower) LCV values while improving the lifetime of the battery 35. Two examples of variable discharging protocols that may be utilized by the BMU 38 for modifying the LCV value based on the number of cycles undergone by the battery 35 and/or the battery pack 34, are shown in Table 1 below:

TABLE 1
Example protocols for periodically modifying
the LCV of the battery cell.

| Protocol | Cycle Number | LCV | |
|---|---|---|---|
| A | 1-50 | 3.0 | V |
| | 51-100 | 2.75 | V |
| | 101-150 | 3.0 | V |
| | 151-200 | 2.5 | V |
| B | 1-50 | 3.0 | V |
| | 51-100 | 2.9 | V |
| | 101-150 | 2.8 | V |
| | 151-200 | 2.7 | V |
| | 201-250 | 2.6 | V |
| | 251-300 | 2.5 | V |

In general, protocol A (e.g., a first or alternating variable discharging protocol) includes charge cycle threshold ranges (e.g., 1-50, 51-100, 101-150, and the like) and LCV values associated with each threshold range. Accordingly, in an embodiment where the BMU controller 38 utilizes the protocol A set forth in Table 1, the BMU controller 38 may determine an LCV for controlling operation of the electronic device 10 by determining whether the number of cycles undergone by the battery 35 (e.g., or one or more battery cells 36 of the battery 35) is within one of the charge cycle threshold ranges and/or less than or equal to a threshold (e.g., a maximum number of cycles within each threshold range). Accordingly, in response to determining the LCV, the BMU controller 38 may decrease the LCV when the number of cycles is within a first charge cycle threshold range (e.g., from 3.0 V for 51-100 cycles down to 2.75 V for 1-50 cycles) and increase the LCV when the number of cycles is within a second charge cycle threshold range after the first number of cycles (e.g., from 2.75 V for 51-100 cycles back up to 3.0 V for 101-150 cycles). It should be noted that protocol A may be continued in this manner (e.g., repeated or followed a similar pattern) for additional cycles beyond the 200 shown in Table 1.

In general, protocol B (e.g., a second or gradually decreasing variable discharging protocol) includes charge cycle threshold ranges (e.g., 1-50, 51-100, 101-150, and the like) and LCV values associated with each threshold range. Accordingly, in an embodiment where the BMU controller 38 utilizes the protocol B set forth in Table 1, the BMU controller 38 may determine an LCV for controlling operation of the electronic device 10 by determining whether the number of cycles undergone by the battery 35 (e.g., or one or more battery cells 36) is within one of the charge cycle threshold ranges and/or less than or equal to a threshold (e.g., a maximum number of cycles within each threshold range). Accordingly, in response to determining the LCV, the BMU controller 38 may decrease the LCV by a static amount (e.g., 0.1 V) each time after 50 cycles are undergone by the battery 35. It should be noted that protocol B may be continued in this manner (e.g., repeated or followed a similar pattern) for additional cycles beyond the 200 shown in Table 1.

It should be noted that the example protocols above are meant to be illustrative and non-limiting. For example, in some embodiments, the BMU 38 may decrease the LCV by a predetermined amount (e.g., decreasing the LCV by 0.05 V, 0.1 V, 0.2 V, or by more than 0.2 V) after a predetermined number of cycles (e.g., after 10 cycles, 25 cycles, 50 cycles, 75 cycles, 100 cycles, or more than 100 cycles.). For example, the BMU 38 may decrease the LCV to a voltage between 1.5 V to 2.75 V, 2.75 V to 2.9 V, 1.5 to 2.0 V, 2.0 V to 2.5 V, and other suitable voltages. In some embodiments, the BMU 38 may decrease the LCV by a varying amount (e.g., decreasing the LCV by 0.05 V after a first number of cycles and decreasing the LCV by 0.1 V after a second number of cycles occurring after the first number of cycles). In some embodiments, the BMU 38 may decrease the LCV to increase the cell capacity of the battery 35 by a predetermined amount (e.g., 1%, 2%, 3%, 4%, 5%, 6%, 7%, 8%, 9%, 10%, 13%, 15%, or more than 15%) after the predetermined number of cycles. In either case, the predetermined number of cycles between each modification of the LCV may vary or be equal between each modification of the LCV. That is, the BMU 38 may decrease the LCV from a first voltage to a second voltage after a first number of cycles. Subsequently, the BMU 38 may decrease the LCV from the second voltage to the third voltage after a second number of cycles have been performed, where the second number is different than the first.

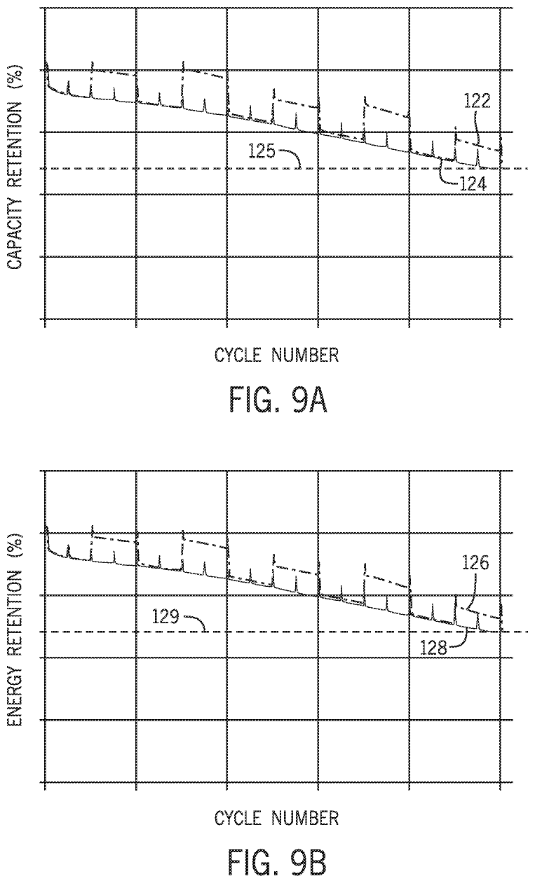

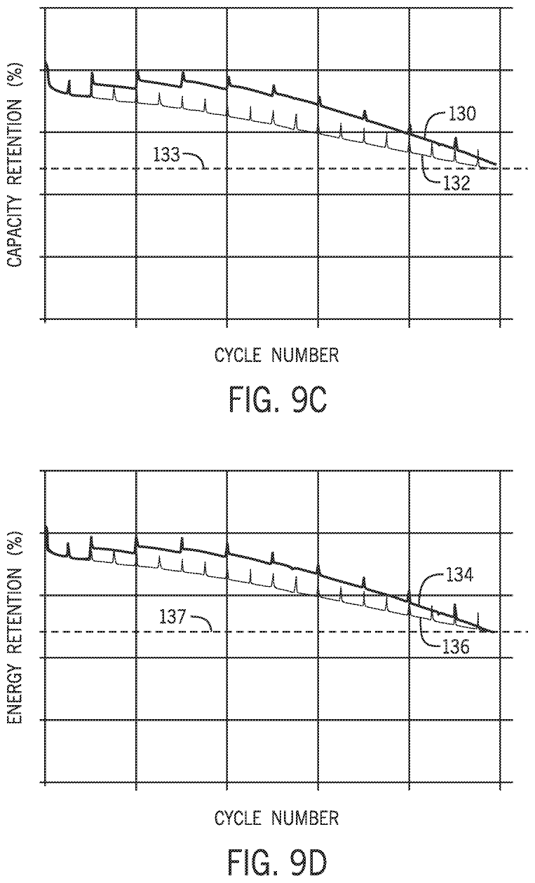

FIGS. 9A-9D generally illustrate capacity retention and energy retention of battery cells 36 utilizing the protocols A and B described above with respect to Table 1, as compared to a discharge protocol using a static (e.g., fixed or unchanging) LCV protocol. That is, during operation of the static LCV protocol, the LCV may not be modified after each charge cycle. FIGS. 9A-9D are based on the battery cell temperature remaining at a constant 25° C. and being charged to an upper cut-off voltage (UCV) of 4.45 V. FIG. 9A is a graph with a horizontal or x-axis representing cycle number and a vertical or y-axis representing capacity retention (%). The graph of FIG. 9A includes curve 122 corresponding to performing protocol A and curve 124 corresponding to the charge cycle protocol with a static LCV (e.g., a static LCV protocol) at 3.0 V. As illustrated, both protocol A and the static LCV protocol were performed until the capacity % reached a threshold capacity represented by the line 125. FIG. 9B is a graph with a horizontal or x-axis representing cycle number and a vertical or y-axis representing energy retention (%). The graph of FIG. 9B includes curve 126 corresponding to performing protocol A and curve 128 corresponding to the static LCV protocol at 3.0 V. As illustrated, both the protocol A and the charge cycle protocol with the static LCV were performed until the energy % reached a threshold capacity represented by line 129.

FIG. 9C is a graph with a horizontal or x-axis representing cycle number and a vertical or y-axis representing capacity retention (%). The graph of FIG. 9C includes curve 130 corresponding to performing protocol B and curve 132 corresponding to the static LCV protocol at 3.0 V. As illustrated, both the protocol B and the charge cycle protocol with the static LCV were performed until the capacity % reached a threshold capacity represented by line 133. FIG. 9D is a graph with a horizontal or x-axis representing cycle number and a vertical or y-axis representing energy retention (%). The graph of FIG. 9D includes curve 134 corresponding to performing protocol B and curve 136 corresponding to the static LCV protocol at 3.0 V. As illustrated, both the protocol B and the static LCV protocol were performed until the energy % reached a threshold capacity represented by line 137. In general, both protocol A (e.g., represented by curves 122 and 126) and protocol B (e.g., represented by curves 130 and 134) provided increased cycle retention with more capacity and energy extracted as evident by the curves for the static LCV protocol (e.g., corresponding to curves 124, 128, 132, and 136) intersecting the threshold lines (e.g., the lines 125, 129, 133, and 137) before the curves 122, 126, 130, and 134.

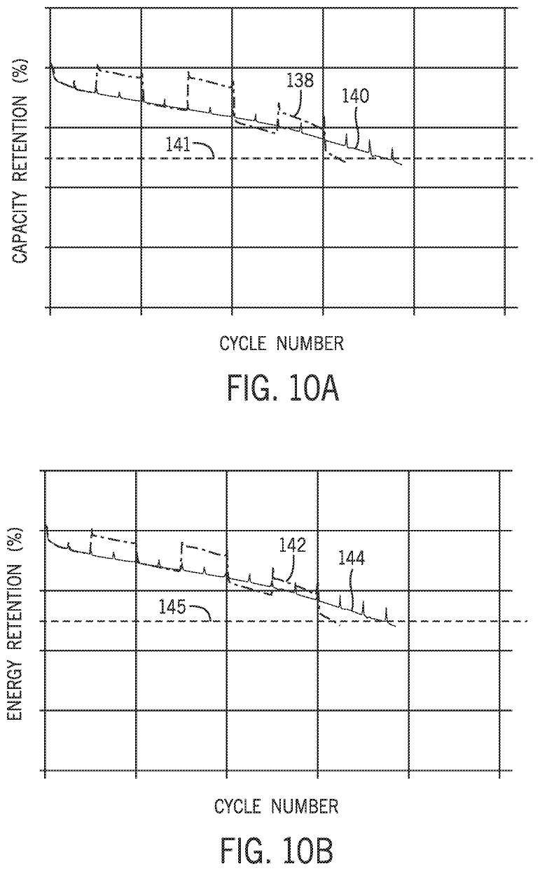

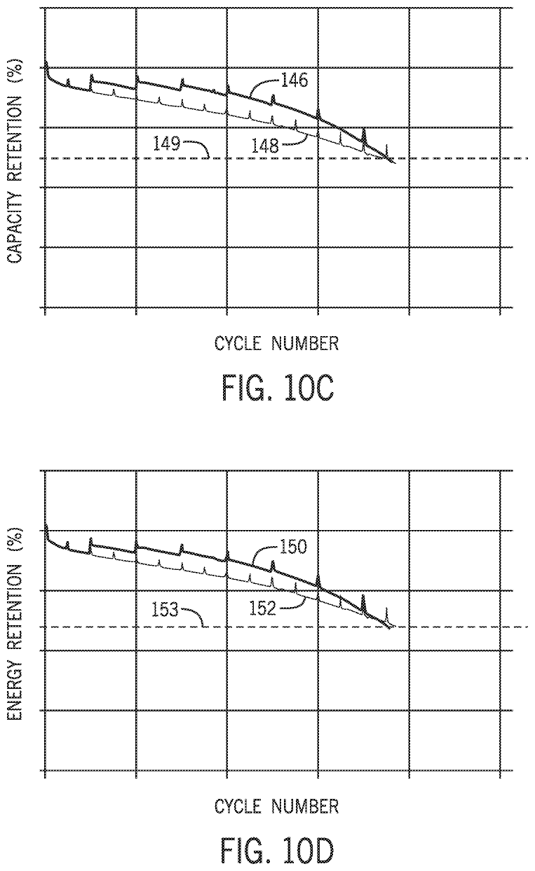

FIG. 10A, 10B, 10C, and 10D (e.g., FIGS. 10A-10D) generally illustrate capacity retention and energy retention of battery cells utilizing the protocols A and B described above with respect to Table 1. FIGS. 10A-10D are based on the battery cell temperature remaining at a constant 45° C. and being charged to an upper cut-off voltage (UCV) of 4.40 V. FIG. 10A is a graph with a horizontal or x-axis representing cycle number and a vertical or y-axis representing capacity retention (%). The graph of FIG. 10A includes curve 138 corresponding to performing protocol A and curve 140 corresponding to the static LCV protocol. As illustrated, both the protocol A and the static LCV protocol were performed until the capacity % reached a threshold capacity represented by the line 141. FIG. 10B is a graph with a horizontal or x-axis representing cycle number and a vertical or y-axis representing energy retention (%). The graph of FIG. 10B includes curve 142 corresponding to performing protocol A and curve 144 corresponding to the static LCV protocol at 3.0 V. As illustrated, both the protocol A and the static LCV protocol were performed until the energy % reached a threshold capacity represented by line 145.

FIG. 10C is a graph with a horizontal or x-axis representing cycle number and a vertical or y-axis representing capacity retention (%). The graph of FIG. 10C includes curve 146 corresponding to performing protocol B and curve 148 corresponding to the static LCV protocol at 3.0 V. As illustrated, both the protocol B and the static LCV protocol were performed until the capacity % reached a threshold capacity represented by line 149. FIG. 10D is a graph with a horizontal or x-axis representing cycle number and a vertical or y-axis representing energy retention (%). The graph of FIG. 10D includes curve 150 corresponding to performing protocol B and curve 152 corresponding to the static LCV protocol at 3.0 V. As illustrated, both the protocol B and the static LCV protocol were performed until the energy % reached a threshold capacity represented by line 153. In general, the graphs depicted in FIGS. 10A-10D show increases in capacity retention and energy retention for the variable discharging protocols A and B. Accordingly, the variable discharging protocols A and B may increase the lifetime and/or energy gain of the battery cells under certain conditions.

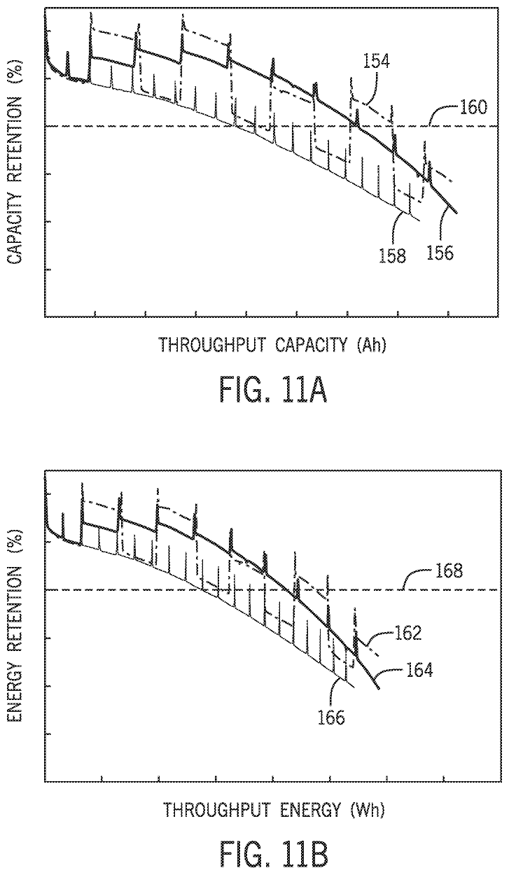

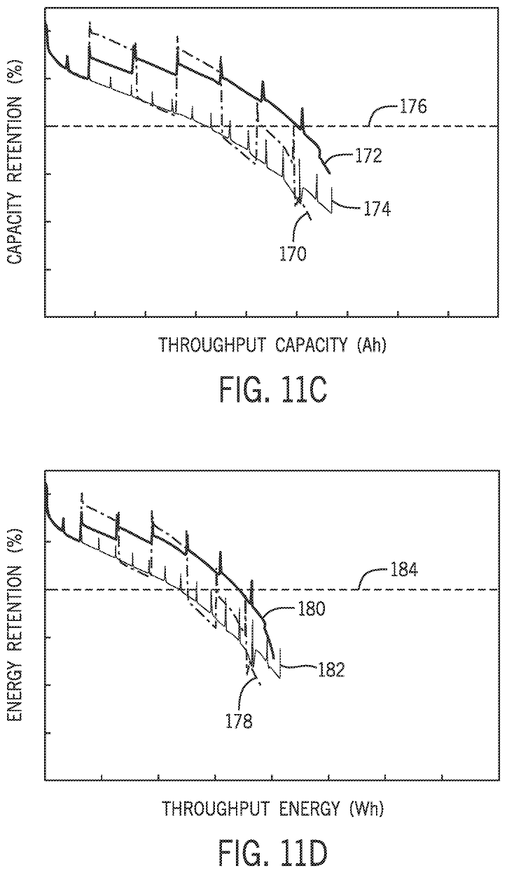

FIGS. 11A-11D generally illustrate throughput capacity and throughput energy of battery cells utilizing the protocols A and B as compared to the static LCV protocol. FIG. 11A is a graph with a horizontal or x-axis representing throughput capacity (Ah) and a vertical or y-axis representing capacity retention (%). The graph of FIG. 11A includes curve 154 corresponding to performing protocol A, curve 156 corresponding to performing protocol B, and curve 158 corresponding to the static LCV protocol at 3.0 V. The threshold capacity line is illustrated with line 160. FIG. 11B is a graph with a horizontal or x-axis representing threshold energy (Wh) and a vertical or y-axis representing energy retention (%). The graph of FIG. 11B includes curve 162 corresponding to performing protocol A, curve 164 corresponding to performing protocol B, and curve 166 corresponding to the static LCV protocol at 3.0 V. The threshold capacity line is illustrated with line 168. FIGS. 11A and 11B correspond to the results of FIGS. 9A-9D, where the battery cell temperature remained at a constant 25° C. and was charged to an upper cut-off voltage (UCV) of 4.45 V.

FIG. 11C is a graph with a horizontal or x-axis representing throughput capacity (Ah) and a vertical or y-axis representing capacity retention (%). The graph of FIG. 11C includes curve 170 corresponding to performing protocol A, curve 172 corresponding to performing protocol B, and curve 174 corresponding to the static LCV protocol at 3.0 V. The threshold capacity line is illustrated with line 176. FIG. 11D is a graph with a horizontal or x-axis representing throughput energy (Wh) and a vertical or y-axis representing energy retention (%). The graph of FIG. 11D includes curve 178 corresponding to performing protocol A, curve 180 corresponding to performing protocol B, and curve 182 corresponding to the static LCV protocol at 3.0 V. The threshold capacity line is illustrated with line 184. FIGS. 11C and 11D correspond to the results of FIGS. 10A-10D, where the battery cell temperature remained at a constant 45° C. and being charged to an upper cut-off voltage (UCV) of 4.40 V. In general, the graphs depicted in FIGS. 11A-11D show increases in throughput capacity and throughput energy for the variable discharging protocols A and B. Accordingly, the variable (e.g., alternating or gradually decreasing) discharging protocols A and B may increase the lifetime and/or energy gain of the battery cells under certain conditions.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A system comprising:
a lithium-ion battery comprising an anode having a silicon anode material; and
a battery management subsystem electrically coupled to the lithium-ion battery, wherein the battery management subsystem comprises one or more processors configured to:
determine a number of cycles undergone by the lithium-ion battery based on a voltage of the lithium-ion battery being below a cut-off voltage; and
modify the cut-off voltage to a modified cut-off voltage for the lithium-ion battery based on the number of cycles undergone by the lithium-ion battery.

2. The system of claim 1, wherein the one or more processors are configured to cause the battery management subsystem to power down a device powered by the lithium-ion battery based on the voltage of the lithium-ion battery being below the cut-off voltage.

3. The system of claim 1, wherein the modified cut-off voltage comprises less than the cut-off voltage.

4. The system of claim 1, wherein the one or more processors are configured to, at a subsequent time:
determine the number of cycles undergone by the lithium-ion battery based on the voltage of the lithium-ion battery being below the cut-off voltage; and
increase the modified cut-off voltage for the lithium-ion battery based on the number of cycles undergone by the lithium-ion battery.

5. The system of claim 1, wherein the modified cut-off voltage is configured to increase a cell capacity of the lithium-ion battery between 3% to 20% as compared to not modifying the cut-off voltage.

6. The system of claim 1, wherein the lithium-ion battery comprises a cathode having a lithium transition metal oxide or lithium transition metal phosphate material.

7. The system of claim 1, wherein the modified cut-off voltage comprises between 2.75 volts and 2.9 volts.

8. The system of claim 1, wherein the modified cut-off voltage comprises between 1.5 volts and 3.2 volts.

9. The system of claim 1, wherein the one or more processors are configured to modify the cut-off voltage by periodically decreasing the cut-off voltage based on the number of cycles undergone by the lithium-ion battery.

10. A method, comprising:
determining, via one or more processors of an electronic device, a voltage of a lithium-ion battery of the electronic device, wherein the lithium-ion battery comprises a silicon anode material;
determining, via the one or more processors, that the voltage is less than a cut-off voltage;
determining, via the one or more processors, a number of times the lithium-ion battery has been charged based on the voltage being less than the cut-off voltage; and
decreasing, via the one or more processors, the cut-off voltage based on the number of times the lithium-ion battery has been charged being greater than a threshold.

11. The method of claim 10, comprising powering down, via the one or more processors, the electronic device based on the voltage of the lithium-ion battery being approximately equal to the decreased cut-off voltage.

12. The method of claim 10, subsequent to decreasing the cut-off voltage:
determining, via the one or more processors, an additional number of times the lithium-ion battery has been charged based on the voltage being less than the cut-off voltage; and
increasing, via the one or more processors, the cut-off voltage based on the additional number of times the lithium-ion battery has been charged being greater than the threshold.

13. The method of claim 10, wherein the cut-off voltage is decreased periodically based on the number of times the lithium-ion battery has been charged being greater than the threshold.

14. The method of claim 10, wherein the threshold is greater than 60 times the lithium-ion battery has been charged based on the voltage being less than the cut-off voltage.

15. A battery management system electrically coupled to a lithium-ion battery, wherein the lithium-ion battery comprises a silicon anode material, and wherein the battery management system comprises one or more processors configured to:
determine a number of cycles undergone by the lithium-ion battery in response to determining that a voltage of the lithium-ion battery is below a cut-off voltage; and
modify the cut-off voltage for the lithium-ion battery based on the number of cycles to increase a cell capacity of the lithium-ion battery by greater than 3% as compared to not modifying the cut-off voltage.

16. The battery management system of claim 15, wherein the cut-off voltage comprises between 1.5 volts and 2.75 volts.

17. The battery management system of claim 15, wherein the one or more processors are configured to modify the cut-off voltage for the lithium-ion battery to increase the cell capacity of the lithium-ion battery by greater than 5% as compared to not modifying the cut-off voltage.

18. The battery management system of claim 15, wherein the one or more processors are configured to modify the cut-off voltage for the lithium-ion battery to increase the cell capacity of the lithium-ion battery by greater than 10% as compared to not modifying the cut-off voltage.

19. The battery management system of claim 15, wherein the one or more processors are configured to modify the cut-off voltage by:
receiving a charge cycle threshold; and
decreasing the cut-off voltage based on the number of cycles being less than or equal to the charge cycle threshold.

20. The battery management system of claim 15, wherein the silicon anode material comprises silicon nanoparticles, silicon nanowires, crystalline silicon, amorphous silicon, silicon oxide, silicon carbon composites, silicon metal alloy or any combination thereof.
